(19) United States
(12) Patent Application Publication
(10) Pub. No.: US 2010/0274615 A1
(43) Pub. Date: Oct. 28, 2010

(54) Extendable Collaborative Correction Framework

(76) Inventors: Eran Belinsky, Haifa (IL); Tal Drory, Haifa (IL); Eugeniusz Walach, Haifa (IL)

Correspondence Address: IBM CORPORATION, T.J. WATSON RESEARCH CENTER, P.O. BOX 218, YORKTOWN HEIGHTS, NY, 10598, US

(21) Appl. No.: 12/427,756

(22) Filed: Apr. 22, 2009

(51) Int. Cl. G06Q 10/00; G06N 5/02; G06F 17/00; G06F 3/00

(52) U.S. Cl. 705/9; 706/47; 715/255; 715/751

(57) ABSTRACT

A novel and useful system and method for a collaborative correction framework that allows external applications to interface to it in a manner that will serve specific correction goals. The framework is extendable, enabling registration of additional authorized applications to the framework. These additional registered applications are then available to other applications accessing the framework. The collaborative correction system maintains profiles for both corrective tasks and users. When assigning a task to a user the collaborative correction system finds an appropriate match by comparing their respective profiles.

### FIELD OF THE INVENTION

The present invention relates generally to the field of collaborative correction systems, and more particularly relates to an extendable collaborative correction framework/system for applications.

### SUMMARY OF THE INVENTION

There is provided in accordance with the invention, a computer system for collaborative correction of a digital representation, comprising an analysis subsystem for execution on a processor in the computer system for retrieving the digital representation from a storage subsystem, perform an initial recognition of the digital representation and store the initial recognition to the storage subsystem, a correction subsystem operative for execution on a processor in the computer system for enabling one or more users of the computer system to correct the initial recognition by retrieving the digital representation and the initial recognition from a storage subsystem, displaying the digital representation and the initial recognition on one or more display devices, accepting input from an alpha-numeric input device and storing the input on the storage subsystem and an extendable collaborative correction framework for execution on a processor in the computer system and operative to build one or more applications interacting with the analysis subsystem and the correction subsystem.

The digital representation referenced in the system for collaborative correction of a digital representation hereinabove is from the group consisting of a text document, an image or an audio recording.

The recognition referenced in the system for collaborative correction of a digital representation hereinabove comprises one or more text characters describing the digital representation.

The application referenced in the system for collaborative correction of a digital representation hereinabove comprises a computer program product.

The extendable collaborative correction framework referenced in the system for collaborative correction of a digital representation hereinabove comprises a data definition subsystem operative to characterize collaborative correction information available to the one or more applications interacting with the extendable collaborative correction framework, a result requirement subsystem operative to define information to be returned by the application interacting with the extendable collaborative correction framework, an environment subsystem operative to define one or more rules to be used by the application interacting with the extendable collaborative correction framework and an application program interface subsystem operative to couple the application interacting with the extendable collaborative correction framework with the data definition subsystem, the result requirement subsystem and the environment subsystem.

The information available to the one or more applications interacting with the extendable collaborative correction framework referenced in the extendable collaborative correction framework hereinabove is from the group consisting of user and corrected material data.

The information to be returned by the application interacting with the extendable collaborative correction framework referenced in the extendable collaborative correction framework hereinabove is from the group consisting of corrected data, correction results, corrected metadata and correction performance statistics.

The one or more defined rules to be used by the application interacting with the extendable collaborative correction framework referenced in the extendable collaborative correction framework hereinabove is from the group consisting of profile matching rules, application evaluation rules, content evaluation rules and framework management rules.

The application program interface referenced in the collaborative correction framework hereinabove comprises an application registry component operative to incorporate one or more applications in the collaborative correction framework, a user management component operative to maintain a profile for one or more users of the collaborative correction framework, a task management component operative to maintain a profile for one or more tasks of the collaborative correction framework and a task allocation component operative to assign one or more of the tasks to one or more of the users.

The task allocation component referenced in the application program interface hereinabove identifies a task to be assigned to a user by locating a profile associated with the task in accordance with a profile associated with the user.

There is also provided in accordance of the invention, an application program interface that facilitates extending a collaborative correction framework, comprising a processor configured to execute an application registry component stored on a memory storage device coupled to the collaborative correction framework, the application registry component for integrating one or more computer executable applications, a user management component for execution on a processor for retrieving a user profile from a memory storage device, retrieving a result of a completed corrective task associated with the user profile from the memory storage device, updating the user profile with the retrieved result and storing the updated user profile to the memory storage device, a task management component for execution on a processor for retrieving a task from a memory storage device, calculating a task profile for the retrieved task and storing the task profile to the memory storage device and a task allocation component for execution on a processor for loading a user profile from the memory storage device, loading one or more task profiles from the memory storage device and identifying one of the loaded task profiles as being in accordance with the loaded user profile to the collaborative correction framework.

There is further provided in accordance of the invention, a first method for collaborative correction of a digital representation, the method comprising the steps of retrieving a profile associated with a user performing the collaborative correction, assigning a corrective task to be performed by the user, evaluating the result of the assigned corrective task performed by the user in the first computer process, and providing the evaluated result to a second computer process and updating the retrieved profile with the evaluated result in the second computer process.

The profile associated with the assigned corrective task referenced in the first method for collaborative correction of a digital representation hereinabove task is in accordance with the retrieved profile.

There is also provided in accordance of the invention, a second method for collaborative correction of a digital representation, the method comprising the steps of retrieving a user profile associated with an user performing the collaborative correction, matching a task profile associated with a corrective task to a user profile associated with the user in a first computer process and providing the task profile and user profile to a second computer process, assigning the corrective task to the user, evaluating the result of the assigned corrective task performed by the user in the second computer process, and providing the result to a third computer process and updating the user profile with the evaluated result in the third computer process.

The user profile referenced in the second method for collaborative correction of a digital representation hereinabove comprises a feature vector representing observed characteristics of the user.

The task profile referenced in the second method for collaborative correction of a digital representation hereinabove comprises a feature vector representing characteristics of the digital representation to be corrected.

There is further provided in accordance of the invention computer program product collaborative correction of a digital representation, the computer program product comprising a computer usable medium having computer usable code embodied therewith, the computer usable program code comprising computer usable code configured for retrieving a user profile associated with an user performing the collaborative correction, computer usable code configured for matching a task profile associated with a corrective task to a user profile associated with the user in a first computer process and providing the task profile and the user profile to a second computer process, computer usable code configured for assigning the corrective task to the user, computer usable code configured for evaluating the result of the assigned corrective task performed by the user in the second computer process, and providing the result to a third computer process and computer usable code configured for updating the user profile with the evaluated result in the third computer process.

### BRIEF DESCRIPTION OF THE DRAWINGS

The invention is herein described, by way of example only, with reference to the accompanying drawings, wherein:

FIG. 1 is a block diagram illustrating an example computer processing system adapted to implement the collaborative correction method of the present invention;

FIG. 2 is a block diagram illustrating an example implementation of the collaborative correction system of the present invention;

FIG. 3 is a source code listing illustrating a sample implementation of computer code to implementing the profile driven collaborative correction method of the present invention;

FIG. 4 is a functional block diagram illustrating an example computer processing system implementing the profile driven collaborative correction method of the present invention; and

FIG. 5 is a flow diagram illustrating profile driven collaborative correction method of the present invention.

### DETAILED DESCRIPTION OF THE INVENTION

### Notation Used Throughout

The following notation is used throughout this document:

| Term | Definition |
|---|---|
| API | Application Program Interface |
| ASCII | American Standard Code for Information |
| | Interchange |
| ASIC | Application Specific Integrated Circuit |
| CD-ROM | Compact Disc Read Only Memory |
| CPU | Central Processing Unit |
| DSP | Digital Signal Processor |
| EEROM | Electrically Erasable Read Only Memory |
| EPROM | Erasable Programmable Read-Only Memory |
| FPGA | Field Programmable Gate Array |
| FTP | File Transfer Protocol |
| HTTP | Hyper-Text Transport Protocol |
| I/O | Input/Output |
| LAN | Local Area Network |
| NIC | Network Interface Card |
| OCR | Optical Character Recognition |
| RAM | Random Access Memory |
| RF | Radio Frequency |
| ROM | Read Only Memory |
| SAN | Storage Area Network |
| URL | Uniform Resource Locator |
| WAN | Wide Area Network |
| XML | Extensible Markup Language |

### DETAILED DESCRIPTION OF THE INVENTION

The present invention is a framework for a collaborative correction system that allows external applications to interface to it in a manner that will serve specific correction goals. The framework is extendable, enabling registration of additional authorized applications to the framework. These additional registered applications are then available to other applications accessing the framework.

The framework (or system) defined in the present invention includes a predefined quality measurement matrix. This enables superior applications (i.e. within the framework) to obtain appropriate rewards. Rewards (e.g., points earned towards a score or a financial reward) are received from either the framework owners or from users (or customers) customers submitting correction information to the collaborative correction platform.

The present invention enables applications accessing the collaborative correction framework to match tasks to users. The collaborative correction system maintains profiles for both corrective tasks and users. When assigning a task to a user the collaborative correction system finds an appropriate match by comparing their respective profiles. As a profile associated with a specific user improves, they will be assigned more complicated tasks (i.e. as represented by the task profile).

The present invention is operative to aid in the design of more efficient and flexible collaborative correction systems. Facilitating the addition of corrective tasks to the system coupled with the capability to match users to tasks (i.e. via their respective profiles) enables targeting tasks to either to specific users or specific corrected material data.

As will be appreciated by one skilled in the art, the present invention may be embodied as a system, method, computer program product or any combination thereof. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

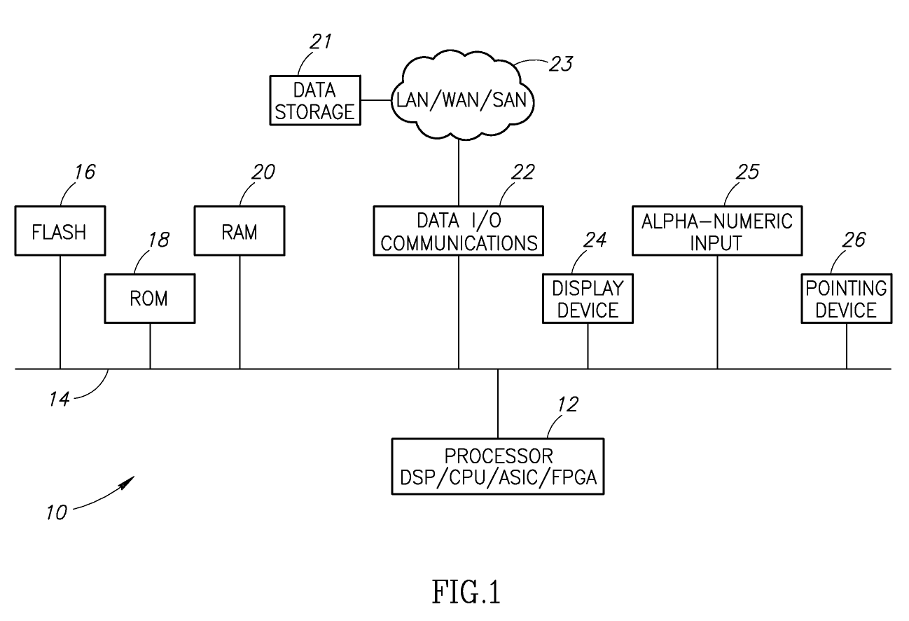

A block diagram illustrating an example computer processing system adapted to implement the extendable collaborative correction system and method of the present invention is shown in FIG. 1. The computer system, generally referenced 10, comprises a processor 12 which may comprise a digital signal processor (DSP), central processing unit (CPU), microcontroller, microprocessor, microcomputer, ASIC or FPGA core. The system also comprises static read only memory 18 and dynamic main memory 20 all in communication with the processor. The processor is also in communication, via bus 14, with a number of peripheral devices that are also included in the computer system. Peripheral devices coupled to the bus include a display device 24 (e.g., monitor), alpha-numeric input device 25 (e.g., keyboard) and pointing device 26 (e.g., mouse, tablet, etc.)

The computer system is connected to one or more external networks such as a LAN or WAN 23 via communication lines connected to the system via data I/O communications interface 22 (e.g., network interface card or NIC). The network adapters 22 coupled to the system enable the data processing system to become coupled to other data processing systems or remote printers or storage devices through intervening private or public networks. Modems, cable modem and Ethernet cards are just a few of the currently available types of network adapters. The system also comprises magnetic or semiconductor based storage device 21 for storing application programs and data. The system comprises computer readable storage medium that may include any suitable memory means, including but not limited to, magnetic storage, optical storage, semiconductor volatile or non-volatile memory, biological memory devices, or any other memory storage device.

Software adapted to implement the extendable collaborative correction system and method of the present invention is adapted to reside on a computer readable medium, such as a magnetic disk within a disk drive unit. Alternatively, the computer readable medium may comprise a floppy disk, removable hard disk, Hash memory 16, EEROM based memory, bubble memory storage, ROM storage, distribution media, intermediate storage media, execution memory of a computer, and any other medium or device capable of storing for later reading by a computer a computer program implementing the system and method of this invention. The software adapted to implement the extendable collaborative correction system and method of the present invention may also reside, in whole or in part, in the static or dynamic main memories or in firmware within the processor of the computer system (i.e. within microcontroller, microprocessor or microcomputer internal memory).

Other digital computer system configurations can also be employed to implement the extendable collaborative correction system and method of the present invention, and to the extent that a particular system configuration is capable of implementing the system and methods of this invention, it is equivalent to the representative digital computer system of FIG. 1 and within the spirit and scope of this invention.

Once they are programmed to perform particular functions pursuant to instructions from program software that implements the system and methods of this invention, such digital computer systems in effect become special purpose computers particular to the system and method of this invention. The techniques necessary for this are well-known to those skilled in the art of computer systems.

It is noted that computer programs implementing the system and methods of this invention will commonly be distributed to users on a distribution medium such as floppy disk or CD-ROM or may be downloaded over a network such as the Internet using FTP, HTTP, or other suitable protocols. From there, they will often be copied to a hard disk or a similar intermediate storage medium. When the programs are to be run, they will be loaded either from their distribution medium or their intermediate storage medium into the execution memory of the computer, configuring the computer to act in accordance with the system and method of this invention. All these operations are well-known to those skilled in the art of computer systems.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or by combinations of special purpose hardware and computer instructions.

### Extendable Collaborative Correction Framework

As discussed supra, the present invention framework of a collaborative correction system (“the framework”) that allows external applications to interface to extend the corrective capabilities of the collaborative correction system. Multiple users accessing collaborative correction applications executing on this framework are typically correcting items such as optical character recognition results, image identification results and natural language processing data. The system first scans in a digital representation (i.e., a scanned text document) and then attempts to translate the digital representation into text (e.g., a series of characters). The system then divides the collaborative correction tasks between system users. The framework of the present invention provides a platform where applications can be registered with the framework and added to the framework library.

In such a collaborative system, there are possibilities to create different applications that serve the purpose of correction, albeit indirectly. An example of an application comprises a game where people are presented with an image of a word, and have to type it in as fast as they can, and where the fastest at each day earns some recognition. While this is a simple example, other examples exist which can be more complex and may require more data as an input from the framework.

Programs accessing the framework have the option of calling a function in the application program interface (API) or a function in the library. The framework of the present invention includes (1) A definition of the collaborative correction data and metadata available to applications accessing the framework, (2) A definition of the required information returned from these applications, (3) A definition of the environment and rules for operating these applications and (4) An API.

Collaborative data available to applications accessing the framework comprises user data and corrected material data. User data is further comprised of background information and statistical information. Examples of user background information include interests, domain (e.g., fiction, non-fiction) and languages. Examples of statistical information include system join date, performance level (i.e. achieved using the system) and statistics on the work the user has accomplished (e.g., how many words/characters/pages/books corrected, number of errors, etc.).

Corrected material data is further comprised of metadata, material type, statistics, data to be corrected and previous data provided by the same or other applications in the framework. Examples of metadata include language, domain and data complexity. Examples of material type include book/newspaper, author, title and identification of the corrected parts (e.g., page, chapter, word number etc.). Statistics examples include data corrected by other users and correction results. Examples of data to be corrected include images of the page/word/characters, OCR results (including confidence) and previous corrections performed by other users (including confidence indicators).

Required information returned from these applications comprises corrected data information, and, optionally, statistics and additional data information. Examples of corrected data information include identification of what was corrected and correction results (including confidence indicators). Statistics examples include elapsed time, number of keystrokes and number of corrections performed. Examples of additional data include specific data provided by the application for further use by other applications at a later time. This data will be provided with a description, (e.g., using XML structure, structure description and semantics). Application may maintain tools and methods for evaluation of the user proficiency. Alternatively, application may us tools provided by the application framework itself.

Environment and rules for operating applications accessing the framework comprises user-application matching, application statistics, evaluation rules and framework manager view. In one embodiment, users wishing to participate in the collaborative system (either implicitly or explicitly) obtain access to an application via the framework. In an alternative embodiment, a user directs their browser to a web site hosting one of the collaborative correction applications and registers with a collaborative correction application hosted on the web site. In this embodiment, the collaborative correction application (i.e. the one registered with the user) delegates the registration process to the framework behind the scenes.

The framework provides means for users to create profiles describing their skills (e.g., known languages, proficiency) and preferences (e.g., preferred material such as novels/fiction, types of preferred applications/games, typical available duration, etc). The framework then matches the user profile with the available application profiles and generates a ranked list of proposed applications, with means to activate them (e.g., a URL for web-based applications or a download link for desktop applications.

After accumulating data on a user's history (provided by the applications), a user's proficiency level may increase or decrease based on the accumulated performance scores. Proficiency level can be calculated at either the individual application level or for all the framework applications accessed by the user. In the game example discussed supra, the framework will propose a specific game application (as a result of user skills vs. application profile) to users based on their willingness to devote either short or long time periods, and the user's skill level in the desired language.

Application statistics (i.e. for the aforementioned environment and rules) are provided as feedback as for their specific application results compared to the results from other applications in the framework. Feedback reflects the quality of identification users achieve using that application vs. the average, median, or any other metric. This can be calculated by comparing aggregated application results against all the applications registered to the framework, or vs. a subset selected by specific rules. Feedback can also reflect application users' demographic statistics, by providing applications with information on its users' skill levels, age, languages (i.e. fluency), etc. This information can be used by application developers to tailor applications for their specific audience. Application developers can also assess the identification quality information received and use it to tweak their applications. Examples of application statistics may include timing information (e.g., the lag between data posting and results retrieval) and the computational load requirement estimates.

Consider the game example discussed supra. If statistics indicate that users are spending very little time on the game, developers might consider introducing game levels, where words get more difficult as the user recognizes more words correctly, thereby adding to the challenge element of the game.

For evaluation rules (i.e. for the aforementioned environment and rules), each application developer would be given the set of rules to be used in their application development. For example, framework owners may be interested in encouraging participation of groups having specific needs or requirements. In this case, the contributions of such groups are measured and evaluated in a predefined manner (i.e. in a manner appropriate to the specific group).

Framework view managers (i.e. for the aforementioned environment and rules) are provided with overall information and specific application information. This information can be used for statistical purposes and reports, as well as for ranking purposes. For example, applications that score low can be removed from the framework, while applications that score high can be featured and more prominently displayed to potential users.

The API of the framework provides a system for registering users and applications, as well as assigning and tracking the work performed by a user. A first embodiment of an API comprises the methods registerApplication, getUserBackground, getTask, reportTask and getAppSpecificData.

When an application is created, the registerApplication method, which receives an application profile, is called to register the application in the framework, and returns a unique application key. When users accessing the application, the application first calls the getUserBackground method, which receives a user ID and the application key. The application then calls the getTask method, which receives a task profile and the application key and then decides on the level of tasks to present to this user by. After a user completes a task, game applications call the reportTask method, passing parameters such as the user's results, corrected data, statistics, and any other application-specific data, to be saved on the framework. In the game example discussed supra, the application-specific data can include the user's identification, information about the day the task was performed and the user's time information (i.e. performance). At a specified time (e.g., once a day), the application calls the getAppSpecificData method and computes that day's fastest results and presents the recognition in a chosen manner. Examples of recognition include prominently displaying the user's name on the application's main page, or sending a coupon via email to the user's email address.

A second embodiment of an API for the framework of the present invention comprises a separate API for user management and applications. For user management the registerUser(Username, password) method registers a new user to the system and returns the variable UserID. The method setUserProperty(UserID, PropertyName, PropertyValue) sets one of the user's profile preferences (e.g., language, age). The method matchApplication(UserID) matches the user's profile against the available applications and returns a sorted list of possible applications which are returned in the variable ApplicationID.

For application management, the method registerApplication(ApplicationProfile) registers application in the framework. The method returns the variable ApplicationKey, which is used by the application to identify itself to the framework. The method getUserBackground(ApplicationKey, UserID) retrieves a specific user's profile and returns the variable UserProfile. The method getUserStats(ApplicationKey, UserID) retrieves a specific user's playing statistics and returns the data structure UserStatistics. The method getTask(ApplicationKey, TaskProfile) retrieves a task for correction based on a specific task selection profile and returns the variable Task. The method reportTask(ApplicationKey, TaskID, CorrectionResults, CorrectionStatistics, UserID, ApplicationSpecifcData) reports on the result of performing the task. Examples of information included in a report include which user performed the task, what were the user's results and statistics and application specific data. The method getAppSpecificData(ApplicationKey) retrieves stored application specific data and returns the data structure ApplicationSpecifcData. The method getRank(ApplicationKey, MetricType) extracts task profile information related to a specific metric and returns the value in variable RankInformation.

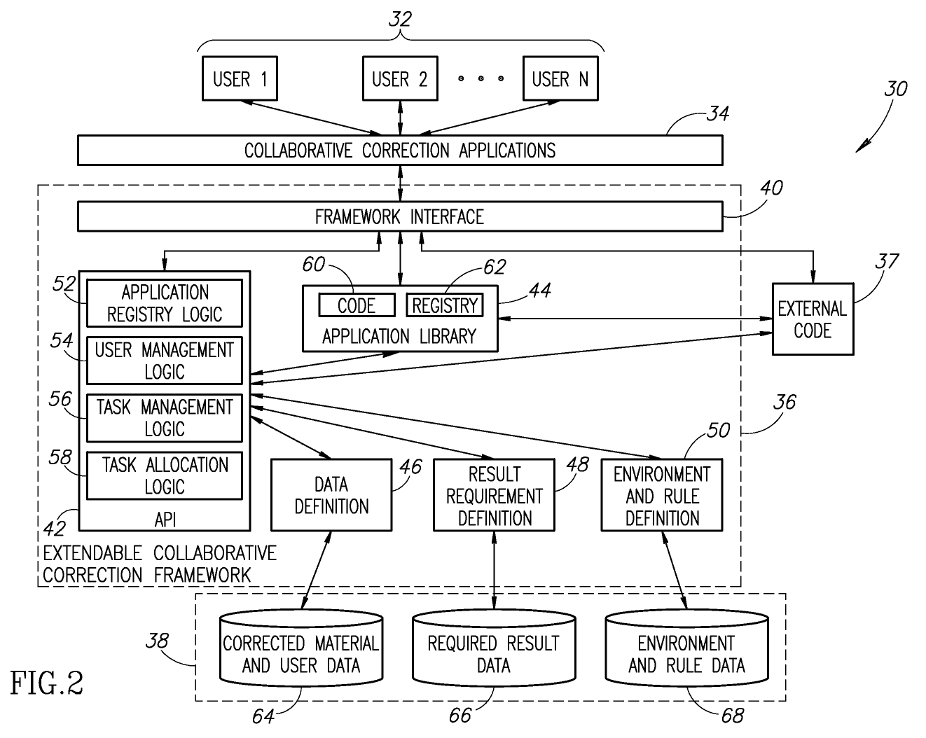

A block diagram illustrating an example computer system implementing the extendable collaborative correction framework of the present invention is shown in FIG. 2. The computer system, generally referenced 30, comprises users 32, collaborative correction applications 34, extendable collaborative correction framework 36, external code 37 and storage system 38. The collaborative correction framework is comprised of framework interface 40, API 42, application library 44, data definition module 46, result requirement definition module 48 and environment and rule module 50. API 40 is comprised of application registry logic 52, user management logic 54, task management logic 56 and task allocation logic 58. Application library 44 is comprised of (internal) code 60 and application registry 62. Storage system 38 is comprised of corrected material and data storage subsystem 64, required result data storage subsystem 66 and environment and rule storage subsystem 68.

In operation, one or more users access the collaborative correction application, which interacts with the extendable collaborative correction framework via the framework interface. The framework interface calls functions either in the API or the application library (whose functions are registered in the application registry). Code for the functions can be either executable code, byte code, (e.g., Java) or source code (i.e. for script based applications). The code can reside either on the collaborative correction system (i.e. internal code) or on any system connected to the collaborative correction system (i.e. external code). For example, a registered application can reside on the computer of a user accessing the collaborative correction system.

The API facilitates registering applications in the application registry via the application registry logic module. In the API, the user management logic module provides methods to maintain user profiles, the task management module provides methods to maintain task profiles and the task allocation logic module provides methods to match tasks to users.

The API also communicates with the data definition module which manages data to be corrected and user data in the corrected material and user data storage subsystem. The result requirement definition module interacts with the API and manages the required information returned from applications (i.e., either within the framework, or applications accessing the framework) on the required result data storage subsystem. The environment and rule definition module interacts with the API and manages the rules governing user-application matching, evaluation rules and application statistics. These data elements are stored on the environment and rules storage subsystem.

### Profile Driven Collaborative Correction

In accordance with the invention, users of a collaborative correction application are empowered to gradually improve in their correction tasks, by controlling the input they receive and adapting it to their appropriate level, proficiency and history. The method of the present invention utilizes the classification of the users by their level of experience (i.e., novice, intermediate, expert) and their actual experience in the system (either usage time or actual amount of text corrected), as well as their history of corrections.

User classifications are matched to the difficulty of the input (e.g., document, word or character) that is to be corrected, so that users will receive input for correction that matches their proficiency. The system maintains the expected error rate at a desired level, by directing low difficulty words for example to novice users, and difficult words (e.g., with low OCR confidence or noisy scanned background) to expert users. The user's history of corrections is used to direct words the user has already corrected (i.e., making it easier for novice users and thus more efficient). Expert users are assigned more challenging tasks in order to reduce the possibility of boredom resulting from repeating the same words too many times. In addition, identification of malicious users by the framework enables their being prevented from accessing the collaborative correction system.

The collaborative correction system maintains a history log for each user, which includes information such as the words the user has previously corrected their various contexts, and the corrected input (i.e. what the user has keyed in). When the system is ready to send the user the next word for correction, the system consults this history to choose the next word according to the following algorithm (not necessarily the optimal one).

For an algorithm implementing the method of the present invention, the history for user U contains a list of words sent in the past to the user U for correction, where, for each word W the history contains a list of corrected words W1 . . . Wm, where these are the corrected words and the associated timestamp of the correction.

For example, the history for user U can look like
[hone, English, Fiction, (home Jan. 1, 2008 08:00) (hose May 1, 2008 09:45)]
   which means the user U received the word ‘hone’ (with the contexts of English and Fiction) on the date Jan. 1, 2008, and corrected it as ‘home’. On May 1, 2008 user U received the word ‘hone’ and this time corrected it as ‘hose’.

In this example, users are classified to these levels according to the time they were actively correcting material in the system: Novice (0-2 months), Working (2-6 months), and Experienced (above 6 months). Users are classified to the proficiency levels Corrector, Expert, and Mentor. The classification is according to the amount of work (i.e. correct corrections) the user has accomplished (e.g., promotion from Corrector to Expert after 10,000 words corrected, etc.). Users accumulate expertise for each of the various contexts (i.e. Expert, Good, and Novice). For example, a user can be considered an Expert in the English context (i.e., the user results in correcting English items are very good), but only considered a Novice in the Latin context. In addition, the same user can be classified as an Expert in Fiction but only classified as Good in the Documentary contexts.

Words are classified to difficulty by the confidence result of the OCR engine when it recognized them, as follows: Very Easy (above 0.9), Easy (between 0.9 and 0.8), Intermediate (between 0.8 and 0.7) and Hard (below 0.7 but not rejected). Note that this confidence rate is a subject of many attributes, for example, scanning quality, type and quality of letters (e.g., letters touching each other), type of font (e.g., ligatures vs. simple font), etc.

In one embodiment, the system maintains a pool of words for correction. The pool contains a list of words, where each word has to be sent for correction to a user, and from which the system can choose the next candidate word to send to the user. For each such word, the pool will include the image of the word (to be presented to the user), the OCR result with its confidence level, the difficulty of the word, and the associated contexts.

In an alternative embodiment, correction is performed at the character level. The same operational principles are applied (i.e. as those for the word level). Character difficulty level is assessed based on the image quality and font. Character difficulty is measured either directly (e.g., by evaluating such parameters as image contrast) or indirectly (e.g., by monitoring the productivity of other users working with similar material).

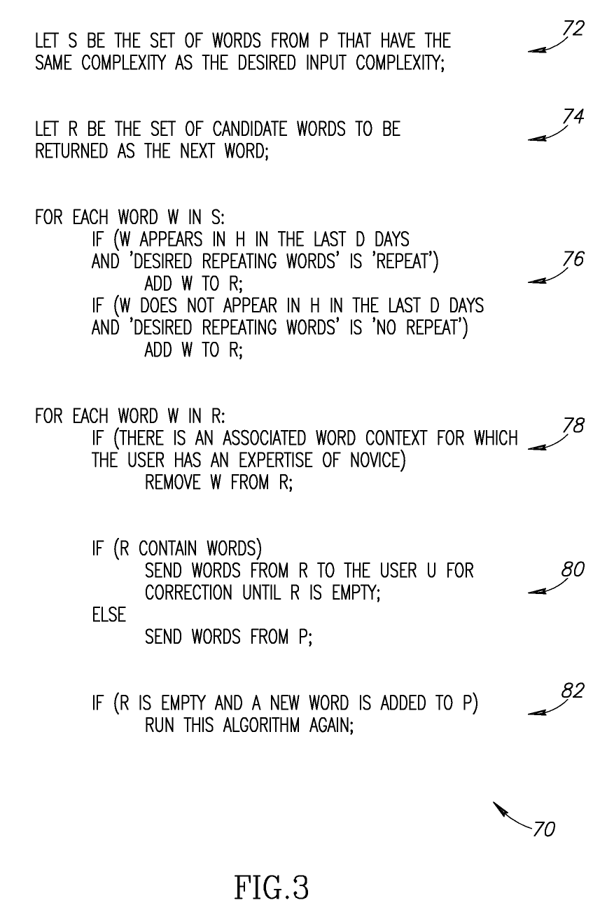

A pseudo-code listing showing an example implementation of the profile driven collaborative correction method of the present invention is shown in FIG. 3. The source code listing, generally referenced 70, comprises code sections 72, 74, 76, 78, 80 and 82. The algorithm implemented in this example describes how to choose the next word W from the pool P for user U with history H.

Assumptions for the algorithm include (1) Each word in P has an associated input difficulty of Very Easy, Easy, Intermediate or Hard, as defined supra. (2) Each word in P has its associated contexts (e.g., English, Fiction). (3) User U has an associated user level of Novice, Working or Experienced. (4) User U has an associated proficiency level of Corrector, Expert or Mentor and (5) User U has an associated expertise of Expert, Good or Novice for each of the various contexts.

Definitions are defined for both (1) desired input complexity and (2) desired completed words. Values for desired input complexity include (1) Very Easy, if U is Novice and Corrector, (2) Very Easy or Easy, if U is Working and Novice, (3) Easy or Intermediate, if is Working and Expert and (4) Hard, for all other values of U. Values for desired repeating words include (1) Repeat, if U is Novice and Corrector, (2) Repeat, if U is Working and Novice, (3) No Repeat, if U is Working and (4) No Repeat, for all other values of U.

In the example pseudo-code listing, section 72 selects the words having the complexity level that suitable to the user's current level. Section 74 creates an empty set (i.e. list) R where candidate words will be added. In section 76, if the user requires repeating words, only the words that appear in the user's history are chosen. Otherwise (i.e. the user does not require repeating words) only words not appearing in the user's history are chosen. Section 78 leaves only the words matching the user's preferred contexts in set R. If set R is empty, then section 80 provides the user with any word from the source data (i.e. that data used to construct R). In section 82, if set R is empty and new words are added to the source data, then the algorithm (i.e. the algorithm represented by this pseudo-code listing) is restarted (i.e. new words might have been added that are appropriate for the user).

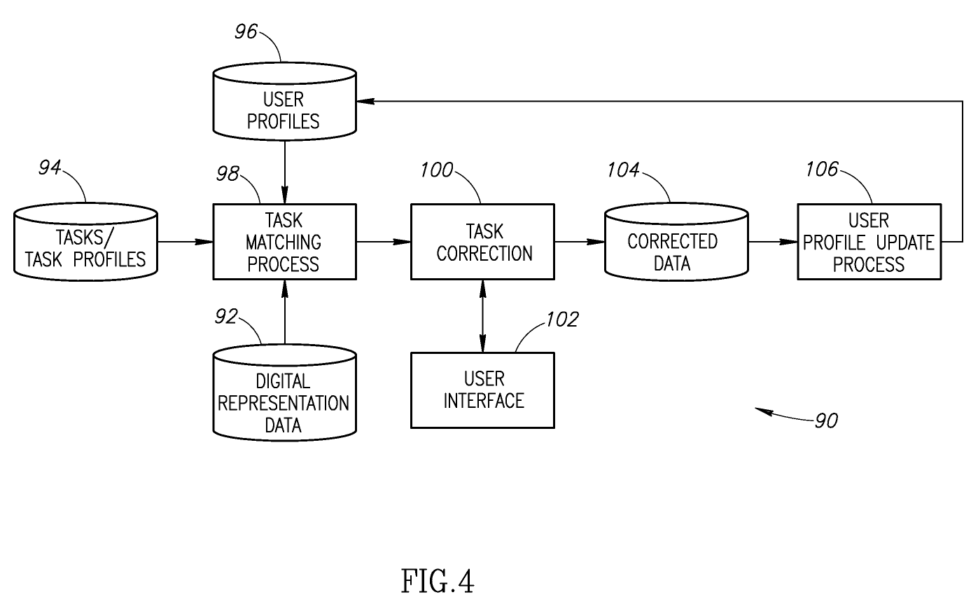

A functional block diagram illustrating an example computer processing system implementing the profile driven collaborative correction method of the present invention is shown in FIG. 4. The computer system, generally referenced 90 comprises digital representation data storage subsystem 92, task and task profile storage subsystem 94, user profile storage subsystem 96, task matching process 98, task correction operation 100, user interface 102, corrected data storage subsystem and user profile update process 106.

In operation, a user logs into the task operation and the user's profile is loaded from the user profile storage subsystem to the task matching process. The task matching process then locates a task with a task profile matching the user profile. The task is retrieved from the task and task profile storage subsystem, and data for the task is retrieved from the digital representation data storage subsystem. The user then performs the corrective task via the user interface and the corrected data is stored in the corrected data storage subsystem. The user profile update process then evaluates the task result and updates the user profile on the user profile storage subsystem.

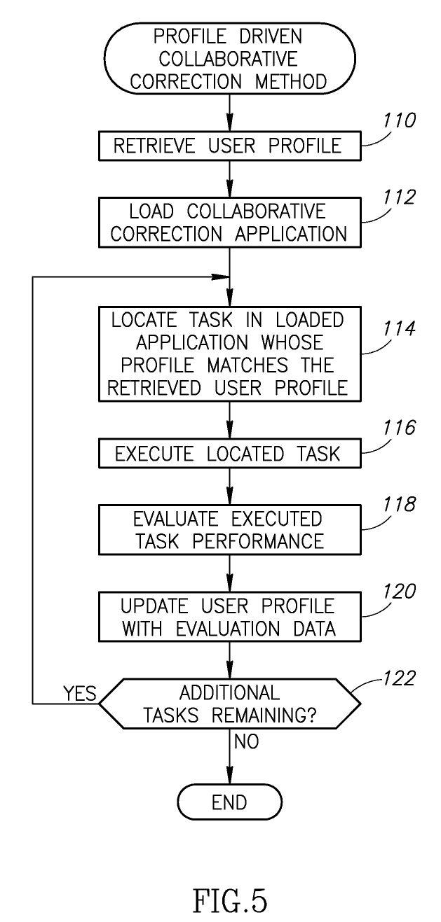

A flow diagram illustrating driven collaborative correction method of the present invention is shown in FIG. 5. First a user profile (i.e. of the user logged into the system) is retrieved (step 110) and a collaborative correction application is loaded (step 112). A task is then located whose task profile closely matches the retrieved user profile (step 114). The located task is executed (step 116), the user's performance (i.e. accuracy, time) is evaluated (step 118) and the user's profile is updated (step 120). If there are additional tasks to be performed (step 122), then the method of the present invention returns to step 114. Otherwise the method of the present invention completes successfully.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

It is intended that the appended claims cover all such features and advantages of the invention that fall within the spirit and scope of the present invention. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention.

What is claimed is:

1. A computer system for collaborative correction of a digital representation, comprising:
an analysis subsystem for execution on a processor in said computer system for retrieving said digital representation from a storage subsystem, perform an initial recognition of said digital representation and store said initial recognition to said storage subsystem;
a correction subsystem operative for execution on a processor in said computer system for enabling one or more users of said computer system to correct said initial recognition by retrieving said digital representation and said initial recognition from a storage subsystem, displaying said digital representation and said initial recognition on one or more display devices, accepting input from an alpha-numeric input device and storing said input on said storage subsystem; and
an extendable collaborative correction framework for execution on a processor in said computer system and operative to build one or more applications interacting with said analysis subsystem and said correction subsystem.

2. The system according to claim 1, wherein said digital representation is from the group consisting of a text document, an image and an audio recording.

3. The system according to claim 1, wherein said recognition comprises one or more text characters describing said digital representation.

4. The system according to claim 1, wherein said application comprises a computer program product.

5. The system according to claim 1, wherein said extendable collaborative correction framework comprises:
a data definition subsystem operative to characterize collaborative correction information available to said one or more applications interacting with said extendable collaborative correction framework;
a result requirement subsystem operative to define information to be returned by said application interacting with said extendable collaborative correction framework;
an environment subsystem operative to define one or more rules to be used by said application interacting with said extendable collaborative correction framework; and
an application program interface subsystem operative to couple said application interacting with said extendable collaborative correction framework with said data definition subsystem, said result requirement subsystem and said environment subsystem.

6. The extendable collaborative correction framework according to claim 5, wherein said information available to said one or more applications interacting with said extendable collaborative correction framework is from the group consisting of user data and corrected material data.

7. The extendable collaborative correction framework according to claim 5, wherein said information to be returned by said application interacting with said extendable collaborative correction framework is from the group consisting of corrected data, correction results, corrected metadata and correction performance statistics.

8. The extendable collaborative correction framework according to claim 5, wherein said one or more defined rules to be used by said application interacting with said extendable collaborative correction framework is from the group consisting of profile matching rules, application evaluation rules, content evaluation rules and framework management rules.

9. The extendable collaborative correction framework according to claim 5, wherein said application program interface comprises:
an application registry component operative to incorporate said one or more applications in said collaborative correction framework;
a user management component operative to maintain a profile for one or more users of said collaborative correction framework;
a task management component operative to maintain a profile for one or more tasks of said collaborative correction framework; and
a task allocation component operative to assign one or more of said tasks to one or more of said users.

10. The application program interface according to claim 9, wherein said task allocation component identifies a task to be assigned to a user by locating a profile associated with said task in accordance with a profile associated with said user.

11. An application program interface that facilitates extending a collaborative correction framework, comprising:
an application registry component stored on a memory storage device coupled to said collaborative correction framework, said application registry component for integrating one or more computer executable applications;
a user management component for execution on a processor for retrieving a user profile from a memory storage device, retrieving a result of a completed corrective task associated with said user profile from said memory storage device, updating said user profile with said retrieved result and storing said updated user profile to said memory storage device;
a task management component for execution on a processor for retrieving a task from a memory storage device, calculating a task profile for said retrieved task and storing said task profile to said memory storage device; and
a task allocation component for execution on a processor for loading a user profile from said memory storage device, loading one or more task profiles from said memory storage device and identifying one of said loaded task profiles as being in accordance with said loaded user profile to said collaborative correction framework.

12. The method according to claim 11, wherein said user profile comprises a feature vector representing observed characteristics of a user associated with said user profile.

13. The method according to claim 11, wherein said task profile comprises a feature vector representing characteristics of a digital representation to be corrected

14. A method for collaborative correction of a digital representation, the method comprising the steps of:
retrieving a user profile associated with a user performing said collaborative correction;
assigning one or more corrective tasks to be performed by said user;
evaluating each result of said one or more assigned corrective tasks performed by said user in a first computer process, and providing each said evaluated result to a second computer process; and
updating said retrieved profile with each said evaluated result in said second computer process.

15. The method according to claim 14, wherein said digital representation is from the group consisting of a text document, an image and an audio recording.

16. The method according to claim 14, wherein said recognition comprises one or more text characters describing said digital representation.

17. The method according to claim 14, wherein a profile associated with each said assigned corrective task is in accordance with said retrieved profile.

18. A method for collaborative correction of a digital representation, the method comprising the steps of:
retrieving from a memory storage a user profile associated with a user performing said collaborative correction;
matching one or more task profiles associated with one or more corrective tasks to said retrieved user profile in a first computer process and providing said one or more task profiles and said user profile to a second computer process;
assigning said one or more matched corrective tasks to said user associated with said retrieved user profile;
evaluating each result of said one or more assigned corrective tasks performed by said user in said second computer process, and providing each said result to a third computer process; and
updating said user profile with each said evaluated result in said third computer process.

19. The method according to claim 18, wherein said digital representation is from the group consisting of a text document, an image and an audio recording.

20. The method according to claim 18, wherein said recognition comprises one or more text characters describing said digital representation.

21. The method according to claim 18, wherein said user profile comprises a feature vector representing observed characteristics of said user.

22. The method according to claim 18, wherein said task profile comprises a feature vector representing characteristics of said digital representation to be corrected.

23. A computer program product collaborative correction of a digital representation, the computer program product comprising:
a computer usable medium having computer usable code embodied therewith, the computer usable program code comprising:
computer usable code configured for retrieving a user profile associated with a user performing said collaborative correction;
computer usable code configured for matching one or more task profiles associated with a corrective task to said retrieved user profile in a first computer process and providing said one or more task profiles and said user profile to a second computer process;
computer usable code configured for assigning said one or more matched corrective tasks to said user associated with said retrieved user profile;
computer usable code configured for evaluating the result of each said assigned corrective task performed by said user in said second computer process, and providing each said result to a third computer process; and
computer usable code configured for updating said user profile with each said evaluated result in said third computer process.

24. The computer program product according to claim 23, wherein said digital representation is from the group consisting of a text document, an image and an audio recording.

25. The computer program product according to claim 23, wherein said recognition comprises one or more text characters describing said digital representation.
